(19) United States
(12) Patent Application Publication
(10) Pub. No.: US 2015/0161091 A1
(43) Pub. Date: Jun. 11, 2015

(54) TERMINAL DEVICE, METHOD OF CONTROLLING DISPLAY OF THE TERMINAL DEVICE, AND COMMUNICATION SYSTEM INCLUDING THE TERMINAL DEVICE

(71) Applicant: Samsung Electronics Co., Ltd., Gyeonggi-do (KR)

(72) Inventors: Kyo Yeol Kim, Gyeonggi-do (KR); Hae Chang Song, Gyeonggi-do (KR); Jeong Hyun Ha, Gyeonggi-do (KR); Sang Ki Kang, Gyeonggi-do (KR)

(21) Appl. No.: 14/310,980

(22) Filed: Jun. 20, 2014

(30) Foreign Application Priority Data
Dec. 11, 2013 (KR) 10-2013-0153725

(51) Int. Cl. G06F 17/24; G06F 3/0488; G06F 17/21; G06F 3/0484

(52) U.S. Cl. CPC G06F 17/24; G06F 3/04842; G06F 3/0488; G06F 17/211

(57) ABSTRACT

A terminal device includes a storage medium configured to store a first string and a second string relevant to the first string, a display configured to display the first string on a first screen and the second string on a second screen, and a controller configured to generate sentence-by-sentence matching information between the first string and the second string, and control the scroll of the first screen and the second screen based on the sentence-by-sentence matching information when a certain part of the first string or the second string is selected or a scroll control command for the first screen or the second screen is input. A method includes controlling a scroll of the second screen to allow a corresponding part of the second string matching with a certain part of the first string to be displayed on the second screen when the certain part is selected.

### CROSS-REFERENCE TO RELATED APPLICATION AND CLAIM OF PRIORITY

The present application is related to and claims the benefit under 35 U.S.C. §119(a) of a Korean patent application No. 10-2013-0153725 filed in the Korean Intellectual Property Office on Dec. 11, 2013, the entire disclosure of which is incorporated herein by reference.

### TECHNICAL FIELD

The present disclosure relates to a terminal device, a method of controlling the display of the terminal device, and a communication system including the terminal device.

### BACKGROUND

Together with the development of digital technology, various electronic devices that are capable of communication and processing personal information on the move, such as mobile communication terminals, personal digital assistants (PDAs), electronic notes, smart phones, and tablet personal computers (PCs) have been released. An electronic device includes call functions such as voice calling and video calling, message transmission/reception functions such as short message services (SMS), multimedia message services (MMS), and e-mail services, imaging functions, music playback functions, internet functions, and translation and dictionary functions, in order to increase user convenience.

However, when providing various functions of the electronic device to a user, limitations are imposed by a display. Such limitations may be more troublesome in the case of a mobile electronic device that emphasizes portability. Thus, in order to conveniently provide more information to a user through a limited display, a method of dividing and displaying a display screen into a plurality of sub screens has been proposed.

### SUMMARY

To address the above-discussed deficiencies, it is a primary object to provide a terminal device that may efficiently control a plurality of displayed screens, a method of controlling the display of the terminal device, and a communication system including the terminal device.

The technical objectives of the present disclosure are not limited to the above-mentioned technical objectives, and other technical objectives not mentioned above will be clearly understood by a person skilled in the art from the following description.

According to an embodiment of the present disclosure, a terminal device includes: a storage medium configured to store a first string and a second string relevant to the first string; a display configured to display the first string on a first screen and the second string on a second screen; and a controller configured to generate sentence-by-sentence matching information between the first string and the second string, and control the scroll of the first screen and the second screen based on the sentence-by-sentence matching information when a certain part of the first string or the second string is selected or a scroll control command for the first screen or the second screen is input.

According to an embodiment of the present disclosure, the controller may generate paragraph-by-paragraph matching information between the first string and the second string.

According to an embodiment of the present disclosure, a method of controlling a display of a terminal device includes displaying a first string on a first screen; generating a second string relevant to the first string, generating sentence-by-sentence matching information between the first string and the second string; displaying the second string on a second screen, controlling the scroll of the second screen to allow a corresponding part of the second string matching with a certain part of the first string to be displayed on the second based on the sentence-by-sentence matching information when the certain part is selected.

According to another embodiment of the present disclosure, a method of controlling a display of a terminal device includes displaying a first string on a first screen, generating a second string relevant to the first string, generating sentence-by-sentence matching information between the first string and the second string, displaying the second string on a second screen, and controlling the scroll of the first screen and the second screen based on the sentence-by-sentence matching information when a scroll control command for the first screen or the second screen is input.

According to another embodiment of the present disclosure, a communication system includes: a terminal configured to store a first string, and a server configured to process the first string delivered from the terminal, generate a second string relevant to the first string, and generate sentence-by-sentence matching information between the first string and the second string, wherein the server delivers the second string and the sentence-by-sentence matching information to the terminal, the terminal displays the first string on a first screen and the second string on a second screen, and the terminal controls the scroll of the first screen and the second screen based on the sentence-by-sentence matching information delivered from the server when a certain part of the first string or the second string is selected or a scroll control command for the first screen or the second screen is input.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a terminal device according to an embodiment of the present disclosure;

FIG. 2 is an example of a screen displayed on the display of the terminal device of FIG. 1;

FIGS. 3 and 4 show how the controller in FIG. 1 generates sentence-by-sentence matching information;

FIG. 5 shows how the controller in FIG. 1 generates paragraph-by-paragraph matching information;

FIGS. 6A to 6C depict the scroll control of a controller according to a scroll control command input;

FIGS. 7A to 7C depict the scroll control of a controller when a certain part of a first string is selected

FIGS. 8A to 8C depict the scroll control of a controller when another part of a first string is selected;

FIGS. 9A to 9C depict the scroll control of a controller when yet another part of a first string is selected

FIG. 10 is a flow chart of a method of controlling the display of a terminal device according to an embodiment of the present disclosure;

FIG. 11 is a flow chart of a method of controlling the display of a terminal device according to another embodiment of the present disclosure;

FIG. 12 is a detailed flow chart of step S260 in FIG. 11;

FIG. 13 shows a communication system according to an embodiment of the present disclosure; and

FIG. 14 is a flow chart of the operation of the communication system of FIG. 13.

### DETAILED DESCRIPTION

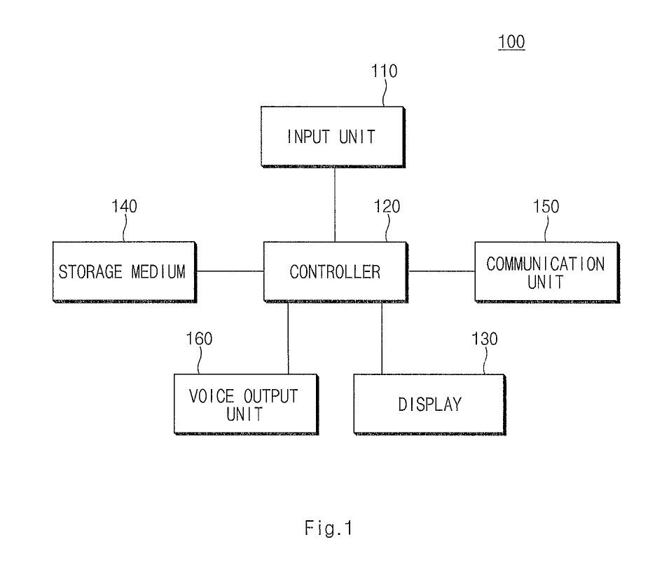

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices.

Some embodiments of the present disclosure are described below in detail with reference to exemplary drawings. It should be noted that when adding reference numerals to components of each drawing, the same components have been given the same reference numerals whenever possible even when they are shown in different drawings. Also, in describing embodiments of the present disclosure, detailed descriptions of related known configurations or functions are not provided if it is determined that such descriptions will impede the understanding of embodiments of the present disclosure.

Also, in describing the components of embodiments of the present disclosure, the terms first, second, A, B, (a) and (b) may be used. These terms are used only for distinguishing one component from another and do not limit the nature or sequence of corresponding components.

FIG. 1 is a block diagram of a terminal device according to an embodiment of the present disclosure.

Referring to FIG. 1, a terminal device 100 according to an embodiment of the present disclosure can include an input unit 110, a controller 120, a display 130, a storage medium 140, a communication unit 150, and a voice output unit 160.

The input unit 110 can obtain a string (hereinafter, referred to as “a first string”) from a user. The input unit 110 can obtain strings such as various languages (including Korean, English, Japanese, and Chinese), symbols, or special characters according to the settings of the terminal device 100. The input unit 110 can include at least one of a key pad, a dome switch, a (static pressure/capacitive) touch pad, a jog wheel, and a jog switch. Also, the input unit 110 can also include a voice recognition module that recognizes and converts a user's voice into a string. The first string obtained through the input unit 110 can be stored in the storage medium 140.

In the following, the input unit 110 is assumed to be a touch pad and description will be provided to the effect that the touch screen of the input unit 110 is activated through the touch panel of the display 130. Thus, a user can input a string through various character inputs and touch screens (such as vowel and consonant input and touch screens in the case of Korean) of the input unit 110 activated on the screen of the display 130. Since the configuration and operation of the input unit 110 can be well known, their detailed descriptions are not provided herein.

The controller 120 can process the first string and generate a second string relevant to the first string. The controller 120 can process the first string input through the input unit 110 or the first string stored in the storage medium 140 and generate the second string. For example, the controller 120 can translate the first string and generate the second string, but the present disclosure is not limited thereto. The term “relevancy” will be understood as a concept that the first string and the second string represent the same matter or have certain relevancy through designation. The generated second string can be stored in the storage medium 140.

In the following, in order to increase the understanding of the present disclosure and for the convenience of description, it will be assumed that the controller 120 translates the first string and generates the second string. That is, the second string can be understood as a string that is obtained by translating the first string into another language. For example, the controller 120 can translate the first string into a language selected by a user, and will translate the first string according to a preset rule and a program and generate the second string. Also, the controller 120 can translate the first string on a line feed character basis, for example. Thus, the numbers of the line feed characters of the first string and the second string will be the same.

The controller 120 can control the display 130 so that the first string and the second string are respectively displayed on separate screens through the display 130. For example, the controller 120 can control the display 130 so that the first string is displayed on a first screen and the second string is displayed on a second screen that does not overlap with the first screen.

Also, the controller 120 can generate matching information between the first string and the second string. For example, the controller 120 can generate matching information between the first string and the second string sentence by sentence or paragraph by paragraph. That is, the matching information can be understood as information representing which sentence or paragraph of the second string (e.g., a translation) the sentence or paragraph of the first string (e.g., the original) corresponds to.

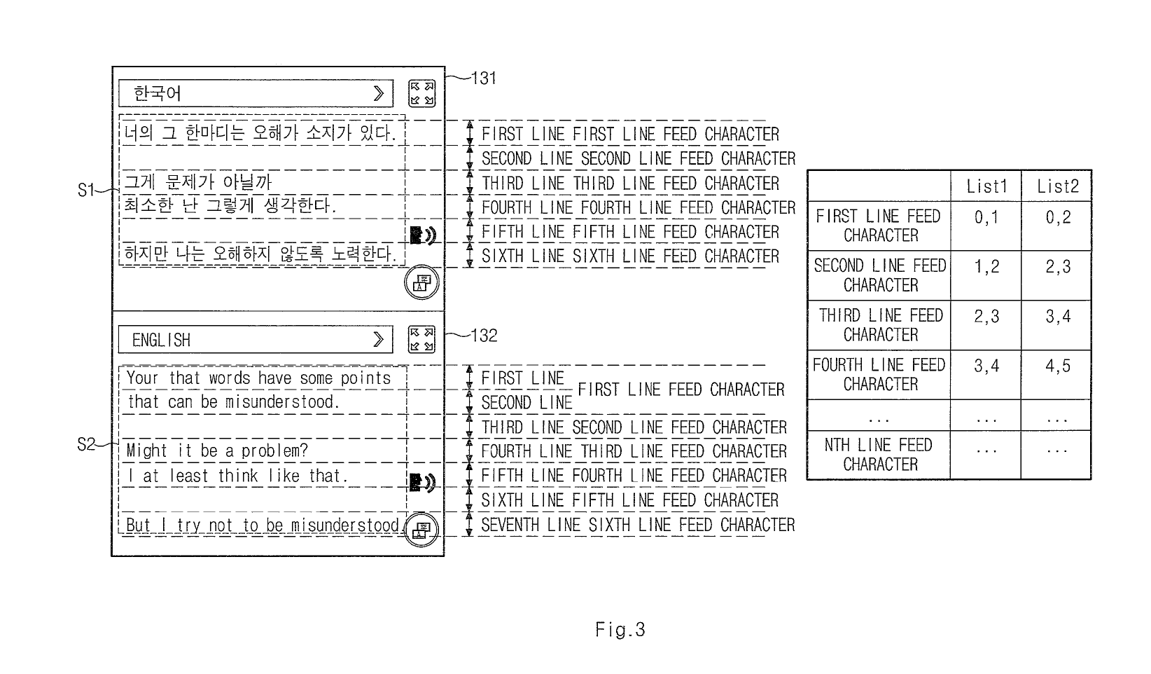

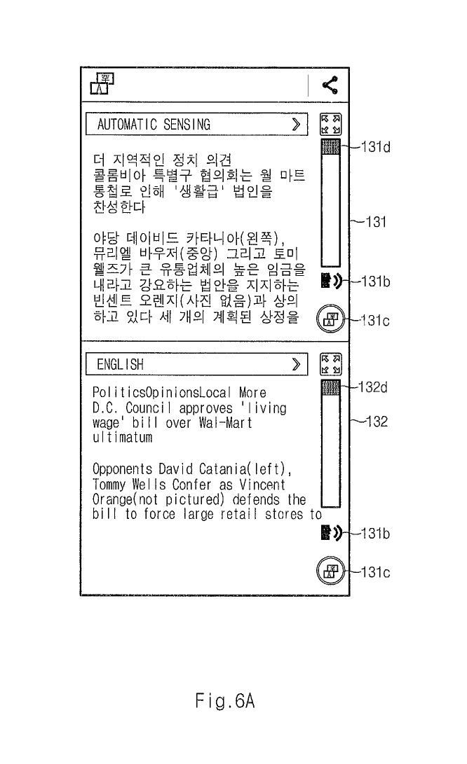

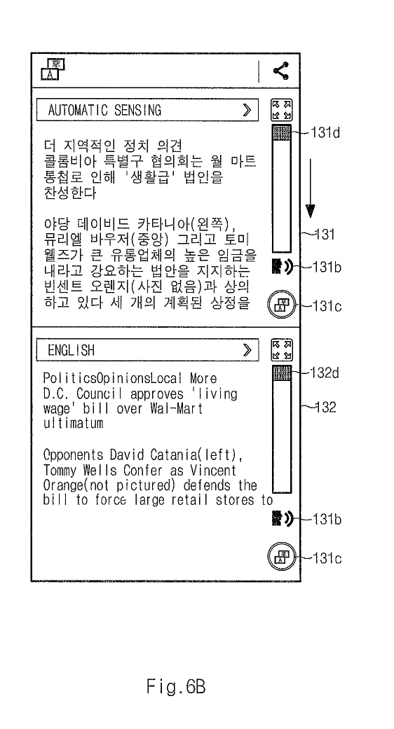

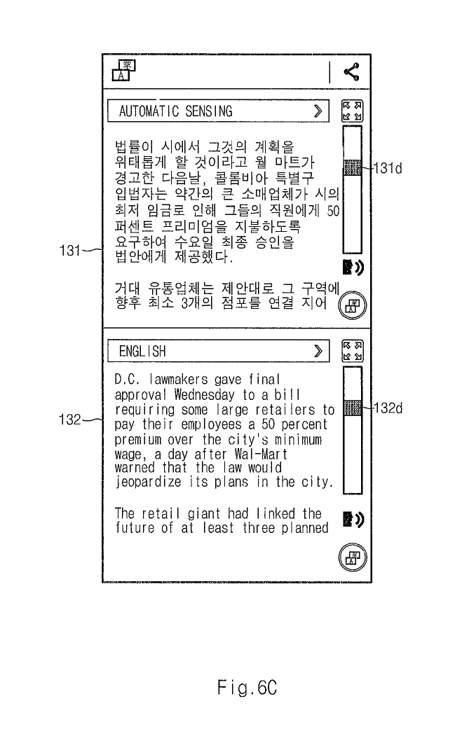

When a certain part of the first string or the second string is selected from a user by using the generated matching information or a scroll control command for the first screen or the second screen is input, the controller 120 can control the scroll of the first screen and the second screen. The certain part can be a word, a sentence or a paragraph, for example. Generating the matching information by the controller 120 will be described in more detail with reference to FIGS. 3 to 5, and a process of controlling the scroll of the first screen and the second screen by the controller 120 by using the generated matching information will be described in more detail with reference to FIGS. 6a to 9c.

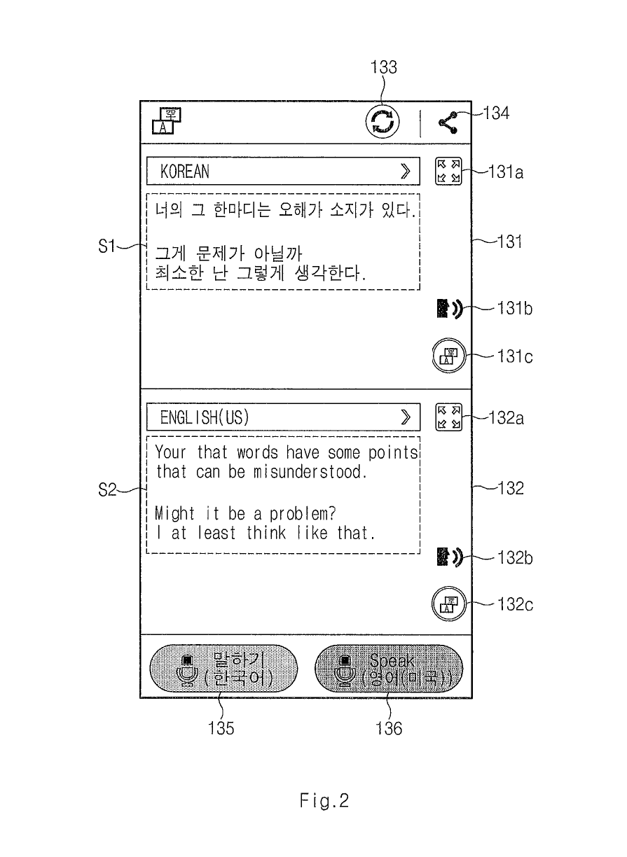

The display 130 can provide the first screen and the second screen. That is, the display 130 can appropriately divide a screen and provide the divided screens in order to display a plurality of content items together. Although the present embodiment assumes that the screen is divided into two screens in order to display the first string and the second string, the present disclosure is not limited thereto and the display 130 can provide three or more screens according to embodiments. For example, the display 130 can display the first string input from a user on the first screen and the second string being a translation of the first string on the second screen. The first screen and the second screen can be displayed in the same size. The first screen and the second screen can have independent scroll operations. The first screen and the second screen displayed through the display 130 will be described in detail with reference to FIG. 2.

On the other hand, the display module 130 can include at least one of a liquid crystal display (LCD), a thin film transistor-LCD (TFT LCD), a light emitting diode (LED), an Organic LED (OLED), an active matrix OLED (AMOLED), a flexible display, a “bended” display, and a 3D display. Some of these displays can be implemented as transparent displays that are transparent or optically transferable to enable viewing of the outside.

Also, as described above, the display module 130 can be provided as a touch screen including a touch panel and thus include a function of the input unit 110. The touch panel can deliver a user input associated with a user gesture relative to the display 130, to the control module 160. In this example, the user input caused by fingers or a touch unit such as a touch pen can include a touch, multiple touches, a tap, double taps, a long tap, tap and touch, drag, a flick, a press, pinch in, and pinch out.

The storage medium 140 can temporarily or permanently store the first string input through the input unit 110 and/or the second string generated by the controller 120. Also, the storage medium 140 can store matching information between the first string and the second string. The storage medium 140 can include, as a storage medium, at least one of: flash memory type, hard disk type, micro type and card type (for example, secure digital (SD) card or extreme digital (XD) card) memories; and one of random access memory (RAM), static RAM (SRAM), read-only memory (ROM), programmable ROM (PROM), electrically erasable PROM (EEPROM), magnetic RAM (MRAM), magnetic disk and optical disk type memories.

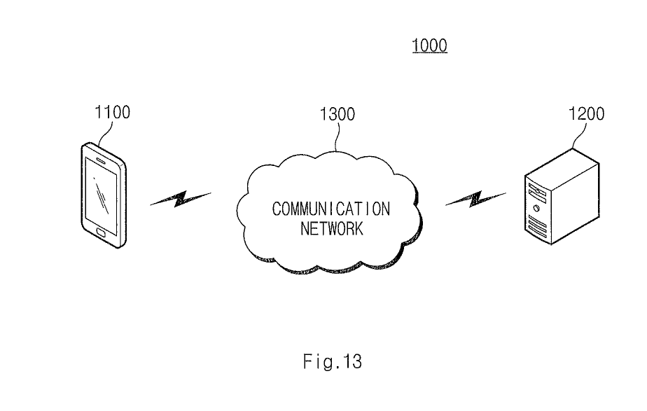

The communication unit 150 can transmit the first string and the second string to another terminal device. In this example, the other terminal device denotes a terminal device of which the user is not the same as the user of the terminal device 100, and will be understood as a concept incorporating mobile communication terminals, PDAs, electronic schedulers, smart phones, tablet PCs, and PCs. The communication unit 150 can transmit the first string and the second string to the other terminal device by using various formats, such as an e-mail or a file. Thus, it is possible to share data between a plurality of users. Also, the communication unit 150 can also deliver the input first string to an external server for translation and a related description will be made below in more detail with reference to FIG. 13.

The voice output unit 160 can voice-output the first string input through the input unit 110 and/or the second string generated by the controller 120 by using a preset corresponding language. As described above, the terminal device according to an embodiment of the present disclosure can generate matching information between the first string and the second string displayed on different screens, and when a certain part of the first string or the second string is selected from a user or a scroll control command for the first screen or the second screen is input, the terminal device 100 can control the scroll of the first screen and the second screen by using the matching information.

That is, for example, when the certain part of the first string is selected from the user, the controller 120 can detect a part of the second string corresponding to the certain part by using matching information, and control the scroll of the second screen so that the detected part is displayed on the second screen. Also, when the certain part of the second string is selected from the user, the controller 120 can detect a part of the first string corresponding to the certain part by using matching information, and control the scroll of the first screen so that the detected part is displayed on the first screen.

Also, when the scroll control command (such as a command to scroll up/down) for the first screen or the second screen is input from the user, the controller 120 can control the scroll of the first screen and the second screen together by using matching information.

Thus, user readability and understanding of the first string (e.g., the original) and the second string (e.g., a translation) can be enhanced. It can be more effective when the first string is long and it is possible to decrease the burden of searching which part of the second string the certain part of the first string corresponds to, through separate scroll control.

FIG. 2 is an example of a screen displayed on the display of the terminal device of FIG. 1. Although FIG. 2 shows that the first string is displayed within the display range of the first screen for convenience of description, the first string can depart from the display range of the first screen according to embodiments when the string is long. The display range can be understood as a range in which the first screen can display a string without a scroll operation. As described with reference to FIG. 1, it is assumed that the controller 120 translates the first string and generates the second string.

Referring to FIG. 2, the display 130 can provide a first screen 131 and a second screen 132. Although FIG. 2 shows that the first screen 131 is displayed on the upper part and the second screen 132 is displayed on the lower part, the present disclosure is not limited thereto. As described with reference to FIG. 1, the first string S1 can be displayed on the first screen 131 and the second string S2 can be displayed on the second screen 132. Also, the first string S1 is shown as Korean and the second string S2 is shown as English, but the present disclosure is not limited thereto, and it will be well understood that various languages can be provided according to user settings and the program design.

Also, the display 130 can provide various preset user interfaces. When each user interface is selected by a user, the controller 120 can control the input unit 110, the display 130, the communication unit 150, and the voice output unit 160 so that a corresponding function is performed.

An enlargement interface 131a can increase the size of the first screen 131 so that the first screen 131 is displayed as the entire screen of the display 130. To this end, the controller 120 can control the display 130. The voice input interface 131b can set the string input mode of the input unit 110 as a voice input mode. To this end, the controller 120 can control the input unit 110 and change an input means to, for example, a microphone (not shown) and a voice recognition module (not shown).

A language selection interface 132c can change a language input to the input unit 110, to another language (such as English or Chinese).

An enlargement interface 132a of the second screen 132, a voice input interface 132b, and a language selection interface 132c are the same as the enlargement interface 131a of the first screen 131, the voice input interface 131b, and the language selection interface 131c, respectively, and thus they are not described.

Also, the display 130 can provide a synchronization mode setting interface 133 and a sharing interface 134.

The synchronization mode setting interface 133 can set the synchronization modes of the first screen and the second screen. A synchronization mode can mean an operation mode in which the scrolls of the first screen and the second screen are controlled together by the controller 120. For example, a user can control scrolls together on the first screen and the second screen in the synchronization mode selected by the synchronization mode setting interface 133 and control scrolls independently on the first screen and the second screen in a general mode in which the synchronization mode setting interface 133 is not selected.

The sharing interface 134 can transmit the first string S1 and the second string S2 to another terminal device. To this end, the controller 120 will activate the communication unit 150. A first voice output interface 135 can voice-output the first string in a corresponding language. A second voice output interface 136 can voice-output the second string in a corresponding language. To this end, the controller 120 can control the voice output unit 160.

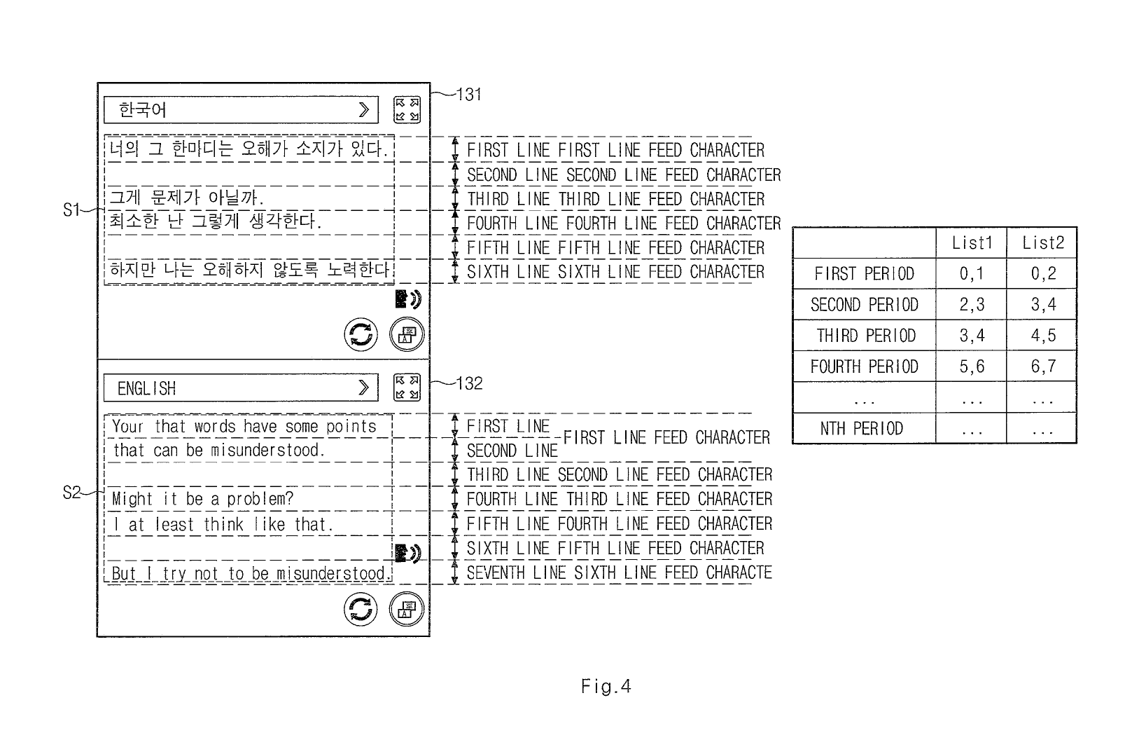

FIGS. 3 and 4 show how the controller in FIG. 1 generates sentence-by-sentence matching information.

In FIGS. 3 and 4, it is assumed that the display 130 displays a string line by line. For example, a preset number of characters can be displayed on one line and when a string includes characters of more than the preset number, the exceeding part of the string will be displayed on the next line. It is assumed that each line has an ordinal from the top of each screen of the display 130, and a string is not displayed on the top and has a zeroth ordinal.

Also, as described with reference to FIG. 1, the controller 120 can translate the first string on a line feed character basis. Thus, the numbers of the line feed characters of the first string and the second string will be the same.

Firstly, referring to FIG. 3, the controller 120 can generate sentence-by-sentence matching information between the first string S1 and the second string S2 by using a line feed character. To this end, the controller 120 can generate information on the locations of the line feed characters of the first string S1 and the second string S2. Each line feed character can have positional information in a (x, y) format. In this example, x can mean an ordinal of the previous line of a sentence started by a line feed character and y can mean an ordinal of a line at which the sentence started by the line feed character ends (where x≧0, y≧0, and x and y are integer numbers).

For example, since each sentence of the first string S1 is displayed on one line, the first string can have a total of six line feed characters including blank lines. That is, a first line feed character of the first string S1 corresponds to a first line and information on the location of the first line feed character can be generated in a (0, 1) format. A second line feed character of the first string S1 corresponds to a second line and information on the location of the second line feed character can be generated in a (1, 2) format. Information on the locations of third to sixth line feed characters of the first string S1 will also be generated by using the above-described method.

On the other hand, a first sentence of the second string S2 exceeds one line. That is, a first line feed character of the second string S2 corresponds to first and second lines and thus information on the location of the first line feed character can be generated in a (0, 2) format. A second line feed character of the second string S2 corresponds to a third line and information on the location of the second line feed character can be generated in a (2, 3) format. Information on the locations of third to sixth line feed characters of the second string S2 will also be generated by using the above-described method.

As a result, the first line feed character of each of the first string S1 and the second string S2 can have matching information, (0, 1) and (0, 2). The second line feed character of each of the first string S1 and the second string S2 can have matching information, (1, 2) and (2, 3).

Thus, when a certain sentence (which has, for example, the third line feed character and location information (2,3)) of the first string S1 is selected from a user, the controller 120 can search for information on the location of a corresponding sentence (which has the third line feed character and location information (3, 4)) of the second string S2 corresponding to the location information on the certain sentence by using matching information, and can control the scroll of the second screen so that a found corresponding sentence is displayed on the second screen.

Also, when the scroll control command (such as a command to scroll up/down) for the first screen or the second screen is input from the user, the controller 120 can search for location information on a line feed character of a corresponding sentence of the other screen (e.g., the second screen) corresponding to location information on a line feed character of the top sentence displayed on the screen (e.g., the first screen) on which the scroll control command is input, by using matching information, and can control the scroll of the first screen and the second screen together.

Next, referring to FIG. 4, the controller 120 can use a period to generate sentence-by-sentence matching information. To this end, the controller 120 can generate location information on the periods of the sentences of the first string S1 and the second string S2.

For example, each of the sentences of the first string S1 can have one period. That is, a first period of the first string S1 can correspond to a first line and information on the location of the first period can be generated in a (0, 1) format. A second period of the first string S1 can correspond to a third line and information on the location of the second period can be generated in a (2, 3) format. Information on the locations of third and fourth periods of the first string S1 will be also generated by using the above-described method

On the other hand, a first sentence of the second string S5 exceeds one line. That is, a first period of the second string S2 can correspond to a second line and information on the location of the first period can be generated in a (0, 2) format. A second period of the second string S2 corresponds to a fourth line and information on the location of the second period can be generated in a (3, 4) format. Information on the locations of third and fourth periods of the second string S2 will be also generated by using the above-described method

As a result, the first period of each of the first string S1 and the second string S can have matching information, (0, 1) and (0, 2). The second period of each of the first string S1 and the second string S can have matching information, (2, 3) and (3, 4).

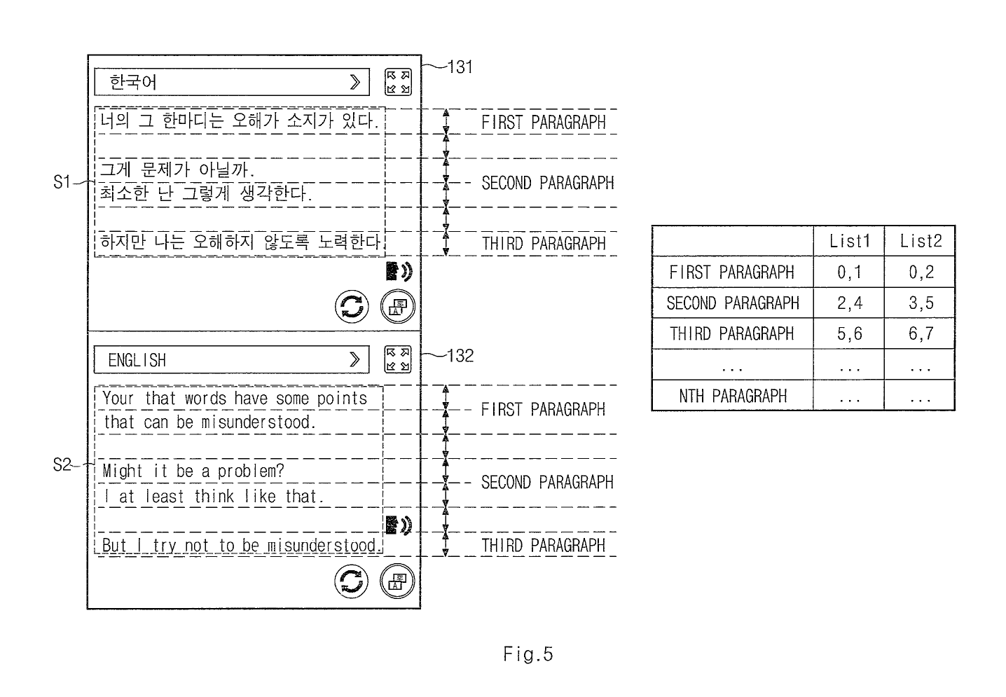

FIG. 5 shows how the controller in FIG. 1 generates matching information paragraph by paragraph.

Referring to FIG. 5, the controller 120 can use location information on a period and a blank line to generate paragraph-by-paragraph matching information. As described with reference to FIG. 4, the controller 120 can use the period to generate sentence-by-sentence matching information between the first string S1 and the second string S2.

In particular, there is a blank line between the first and second sentences of the first string S. When there is a blank line between sentences, location information on the periods can have discontinuity, unlike when the line feed character is used. For example, since there is no period on the second line of the first string S1, location information on the first period can be generated in a (0, 1) format and location information on the second period can be generated in a (2, 3) format. The controller 120 can generate paragraph-by-paragraph matching information based on such discontinuity, and to this end, the controller 120 can generate location information on a sentence based on where the discontinuity of location information is discovered.

That is, the first period of the first string S1 is a first paragraph and information on the location of the first paragraph can be generated in a (0, 1) format. On the other hand, the first sentence of the second string S2 is a first paragraph and information on the location of the first paragraph can be generated in a (0, 2) format. Furthermore, the second and third sentences of the first string S1 are a second paragraph and information on the location of the second paragraph can be generated in a (2, 4) format. On the other hand, second and third sentences of the second string S2 are a second paragraph and information on the location of the second paragraph can be generated in a (3, 5) format.

Thus, when a certain paragraph of the first string S1 is selected from the user, the controller 120 can search for location information on a corresponding paragraph of the second string S2 corresponding to location information on the certain paragraph by using matching information, and can control the scroll of the second screen so that a found corresponding paragraph is displayed on the second screen.

FIGS. 6a to 6c depict the scroll control of a controller according to a scroll control command input.

For convenience of description, it is assumed in FIGS. 6a to 6c that the first string S1 is long and thus a scroll bar 131d is generated. Scroll bars 131d and 132d can be understood as a user interface for controlling the scroll of a screen.

Firstly, referring to FIG. 6a, it is assumed that the scroll bars 131d and 132d of the first screen 131 and the second screen 132 are placed at the tops thereof.

Referring to FIG. 6b, a scroll control command for the first screen 131 is input by a user. The scroll control command can be implemented to enable a user to control the scroll bar 131d. The scroll control command can be a control command to scroll up or down, for example.

Referring to FIG. 6c, according to the scroll control command for the first screen 131 input from a user, the controller 120 can search for location information on a line feed character of a corresponding sentence of the other screen (e.g., the second screen) corresponding to location information on a line feed character of the top sentence displayed on the first screen 131 by matching information, and control the scrolls of the first screen and the second screen together. Thus, the scroll bar 131d and the scroll bar 132d will be controlled upwards or downwards together.

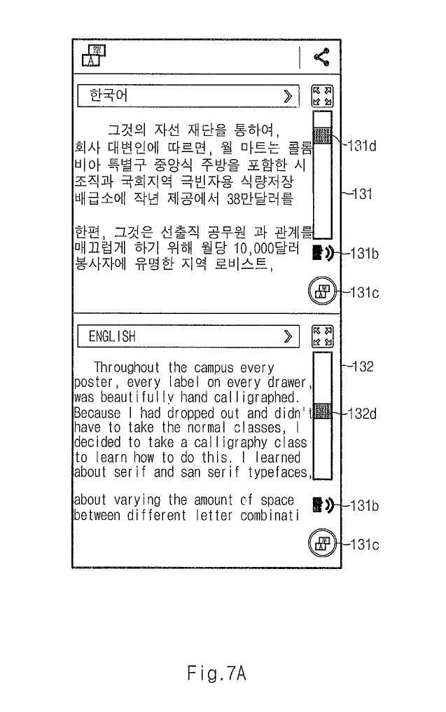

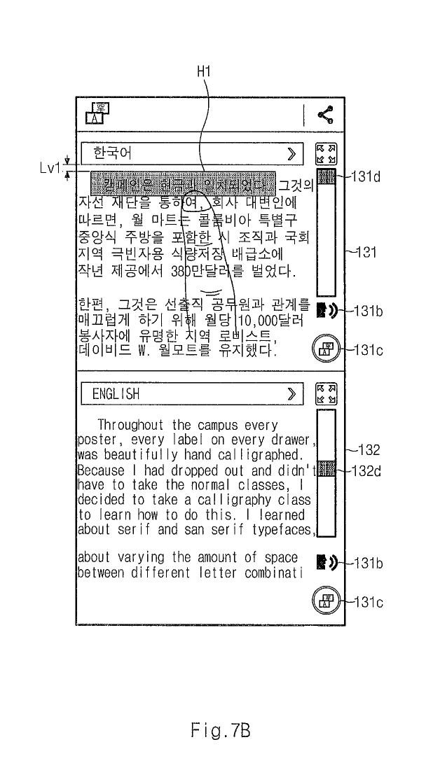

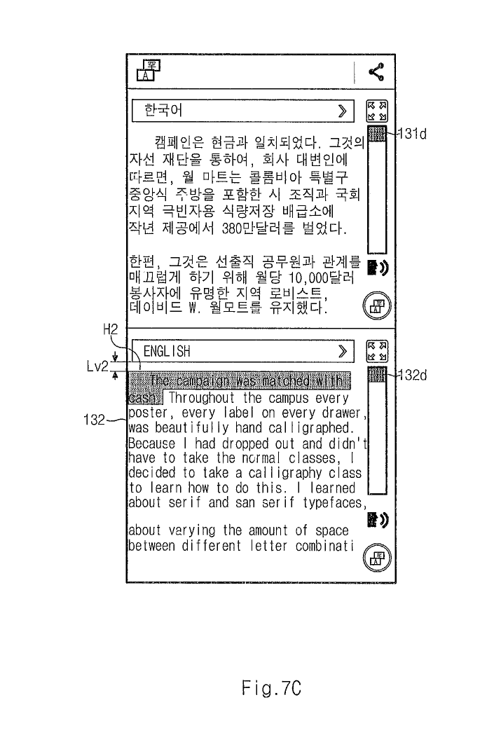

FIGS. 7a to 9c depict the scroll control of a controller when a certain part of a first string is selected. Although FIGS. 7a to 9c show when a certain part of the first string is selected by a user, the present disclosure is not limited thereto and it will be understood that a case where a certain part of a second string is selected by the user can also be applied equally to the technical spirit to be described below.

The detailed descriptions of the enlargement interface 131a, the voice input interface 131b, the language selection interface 131c, the synchronization mode setting interface 133, and the sharing interface 134 that are described with reference to FIG. 2 will not be provided in order to avoid redundancy.

Firstly, referring to FIG. 7a, it is assumed that the first string S1 displayed on the first screen 131 and the second string S2 displayed on the second screen 132 get a scroll mismatch (for example, the first screen and the second screen display mutually irrelevant parts).

Referring to FIG. 7b, a certain part of the first string S1 of the first screen 131 can be selected by a user. For example, the certain part can be selected by a user touch or a contactless proximity touch. The contactless proximity touch can be understood as a technology to sense an access to a screen and perform a function according to a user gesture even if the user does not touch the screen of the display 130. The contactless proximity touch can be called hovering.

Continuing to refer to FIG. 7b, it shows when a certain sentence (e.g., “ [symbol] [symbol] ”) of the first string S1 is selected by a user. The controller 120 can highlight H1 the selected certain sentence, for example. The controller 120 can detect location information on a corresponding sentence (e.g., “The campaign was matched with cash”) of the second string S2 corresponding to location information on a line feed character of the certain sentence selected by the matching information stored in the storage medium 140.

Continuing to refer to FIG. 7b, it shows when a certain sentence of the first string S1 is selected by a user. The controller 120 can highlight H1 the selected certain sentence, for example. The controller 120 can detect location information on a corresponding sentence (e.g., “The campaign was matched with cash”) of the second string S2 corresponding to location information on a line feed character of the certain sentence selected by the matching information stored in the storage medium 140.

Referring to FIG. 7c, the controller 120 can control the scroll of the second screen 132 so that the corresponding sentence is displayed on the second screen 132 by using location information on the corresponding sentence (e.g., “The campaign was matched with cash”) of the detected second string S2. The scroll control of the second screen 132 can be implemented by the control of the scroll bar 132d, for example.

Also, the controller 120 can control the scroll of the second screen 132 so that a level Lv2 of the corresponding sentence (e.g., “The campaign was matched with cash”) of the second string S2 on the second screen 132 is the same as a level Lv1 of the certain sentence (e.g., “ [symbol] [symbol] ”) of the first string S1 on the first screen 131. Furthermore, the controller 120 can highlight H2 the corresponding sentence of the second string S2. Thus, it is possible to further enhance user readability and understanding.

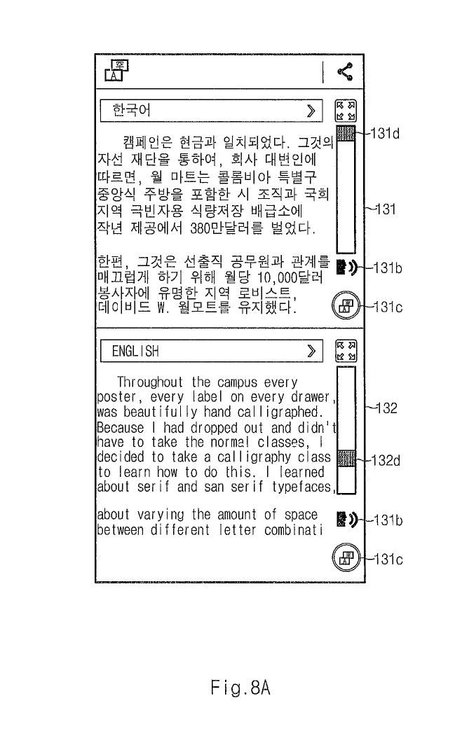

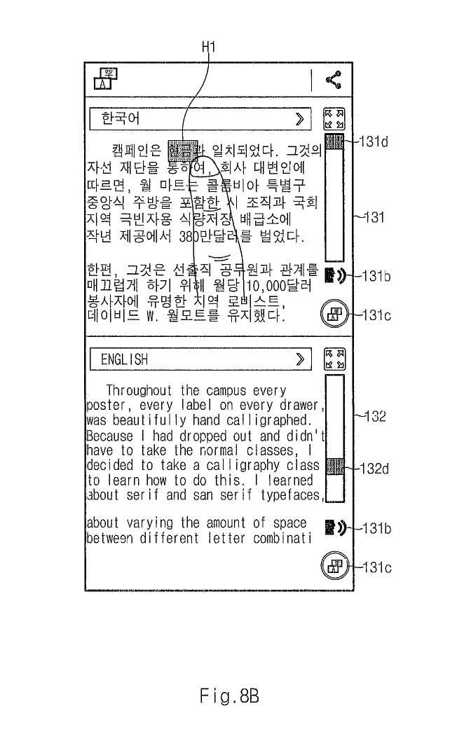

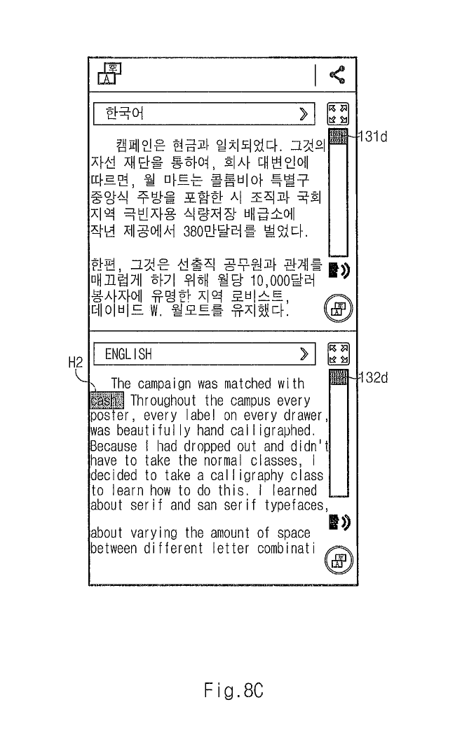

Next, referring to FIG. 8a, it is assumed that the first string S1 displayed on the first screen 131 and the second string S2 displayed on the second screen 132 are not matched, as in FIG. 7a.

FIG. 8b shows when a certain word (e.g., “ [symbol] ”) of the first string S1 is selected by a user. The controller 120 can highlight H1 the selected certain word, for example. The controller 120 can detect location information on a corresponding sentence (e.g., “The campaign was matched with cash”) of the second string S2 corresponding to location information on a line feed character of a sentence including the selected certain word by the matching information stored in the storage medium 140.

Referring to FIG. 8c, the controller 120 can control the scroll of the second screen 132 so that the corresponding sentence is displayed on the second screen 132 by using location information on the corresponding sentence (e.g., “The campaign was matched with cash”) of the detected second string S2. The scroll control of the second screen 132 can be implemented by the control of the scroll bar 132d, for example. Furthermore, the controller 120 can search and highlight H2 a word corresponding to the certain word (e.g., “ [symbol] ”) in the corresponding sentence (e.g., “The campaign was matched with cash”) of the detected second string S2.

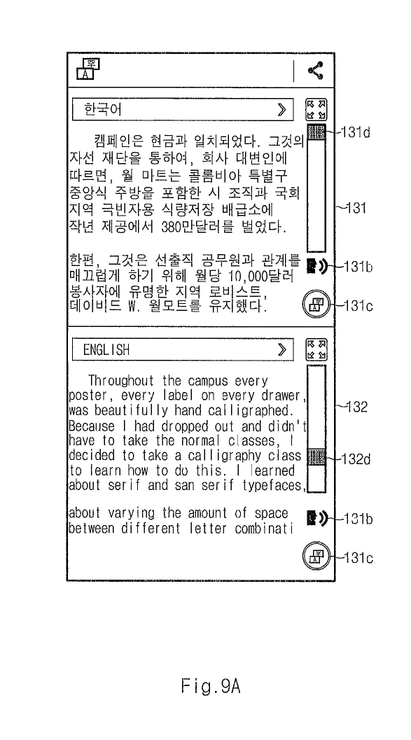

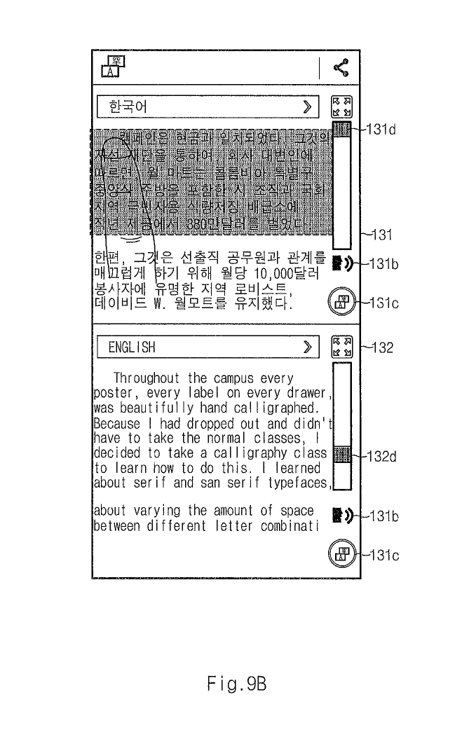

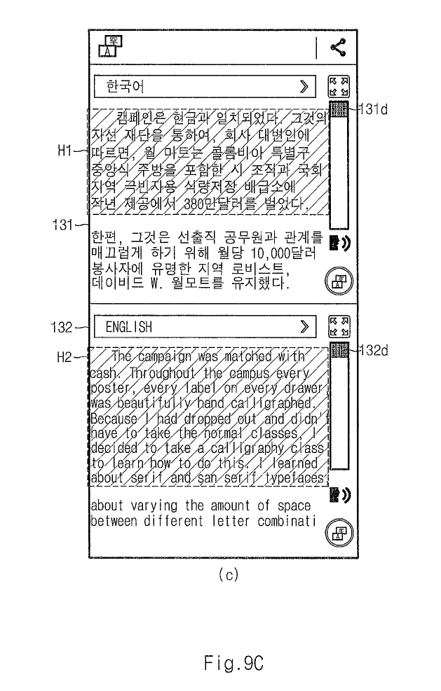

Next, referring to FIG. 9a, it is assumed that the first string S1 displayed on the first screen 131 and the second string S2 displayed on the second screen 132 are not matched, like FIG. 7a.

FIG. 9b shows when a certain paragraph P1 of the first string S1 is selected by a user. The controller 120 can highlight H1 the selected certain paragraph P1, for example. The controller 120 can detect location information on a corresponding paragraph P2 of the second string S2 corresponding to location information on the selected certain paragraph P1 by the matching information (See FIG. 5) stored in the storage medium 140.

Referring to FIG. 9c, the controller 120 can use location information on the corresponding paragraph P2 of the detected second string S2 to control the scroll of the second screen 132 so that the corresponding paragraph P2 is displayed on the second screen 132. The scroll control of the second screen 132 can be implemented by the control of the scroll bar 132d, for example. Furthermore, the controller 120 can highlight H2 the corresponding paragraph P2 of the second string S2.

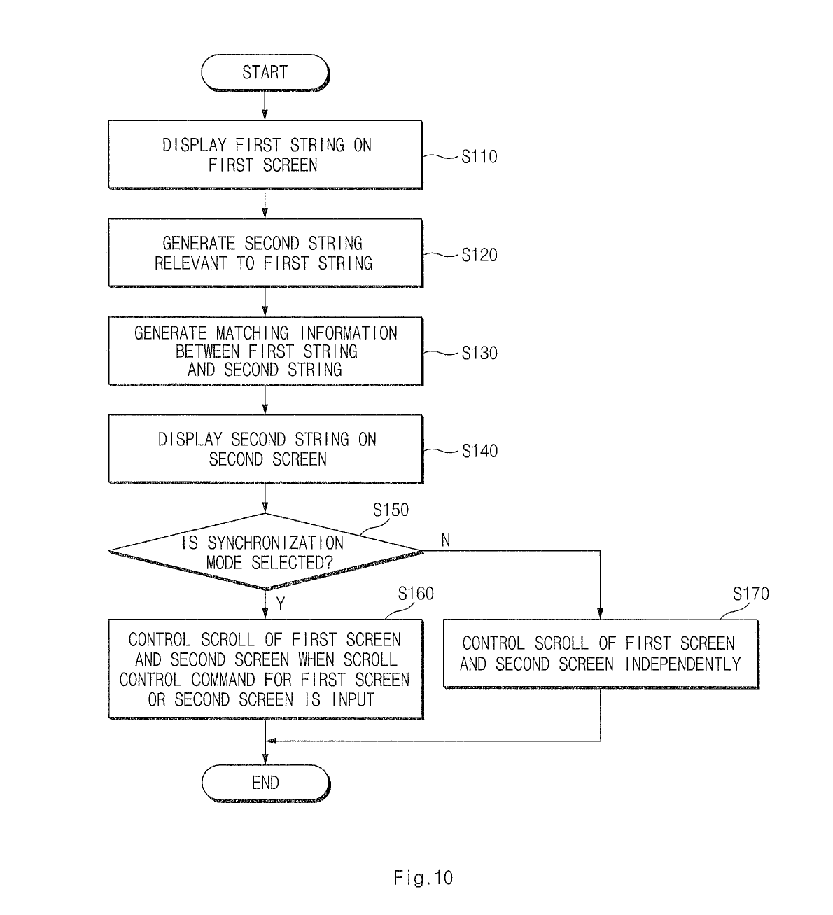

FIG. 10 is a flow chart of a method of controlling the display of a terminal device according to an embodiment of the present disclosure.

Referring to FIG. 10, the method of controlling the display of a terminal device according to an embodiment of the present disclosure can include displaying a first string on a first screen in step S110, generating a second string relevant to the first string in step S120, generating matching information between the first string and the second string in step S130, displaying the second string on the second screen in step S140, determining whether a synchronization mode is selected in step S150, controlling the scroll of the first screen and the second screen in step S160 when a scroll control command for the first screen or the second screen is input, and controlling the scrolls of the first screen and the second screen independently in step S170.

Step S160 can be performed when the synchronization mode is selected as the determination result of step S150, and step S170 can be performed when the synchronization mode is not selected as the determination result of step S150. In the following, each of steps S110 to S170 will be described in detail.

Firstly, in step S110, the controller 130 can display, on the first screen 131, the first string S1 that is input through the input unit 110 or stored in the storage medium 140.

In step S120, the controller 120 can generate the second string S2 relevant to the first string S1.

In step S130, the controller 120 can generate matching information between the first string S1 and the second string S2. The controller 120 can generate sentence-by-sentence or paragraph-by-paragraph matching information on the first string S1 and the second string S2, for example. The process of generating the matching information can be the same as that described with reference to FIGS. 3 to 5.

In step S140, the display 130 can display the second string S2 on the second screen 132. For example, the second screen 132 can be displayed in the same size as the first screen 131 without overlapping with the first screen 131. Also, the second screen 132 can include the same user interfaces as the first screen 131.

In step S150, the controller 120 can determine whether the synchronization mode is selected by a user. The synchronization mode can mean an operation mode in which the scroll of the first screen 131 and the second screen 132 are controlled together by the controller 120. For example, the synchronization mode can be activated when the synchronization mode setting interface 133 (See FIG. 2) is selected by the user. When the synchronization mode is selected, step S160 is performed.

In step S160, when a scroll control command for the first screen 131 or the second screen 132 is input from the user, the controller 120 can control the scroll of the first screen 131 and the second screen 132 together by using the matching information. The detailed scroll control process of the controller 120 is the same as that described with reference to FIGS. 6a to 6c.

On the other hand, in step S170, when a scroll control command for the first screen 131 or the second screen 132 is input from the user, the controller 120 will control the scroll of only the screen to which the scroll control command is input.

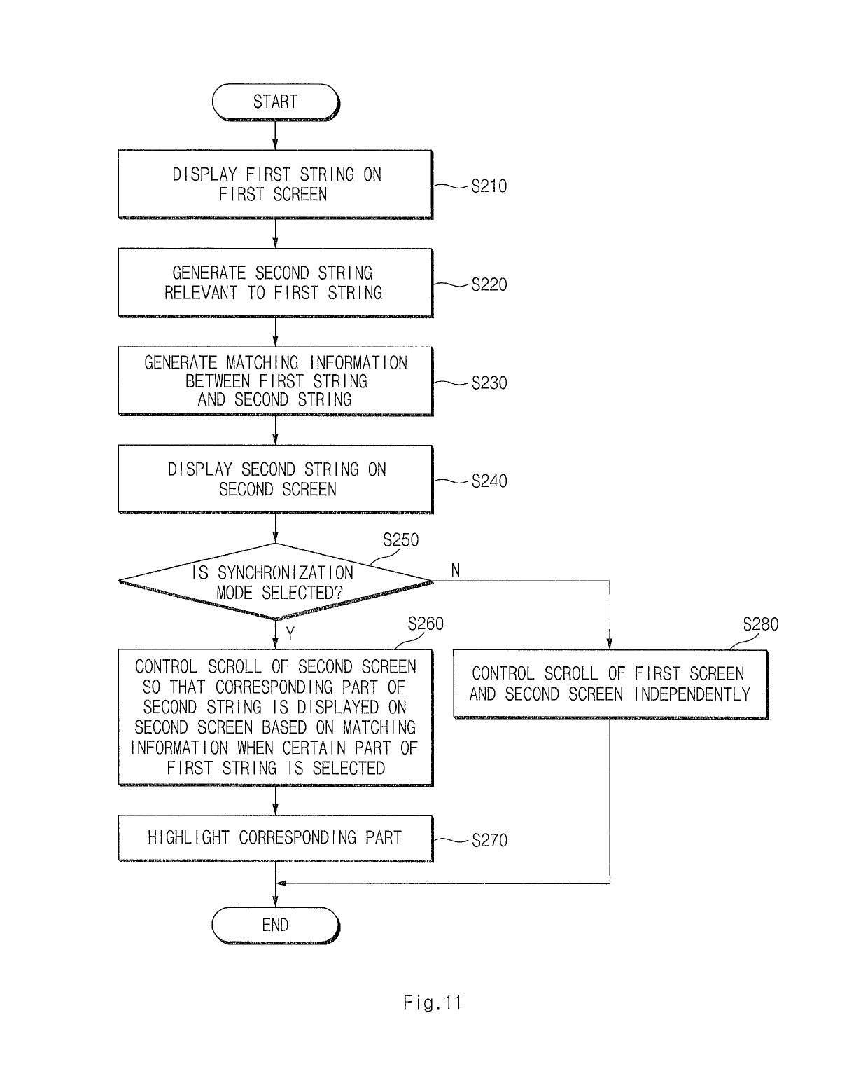

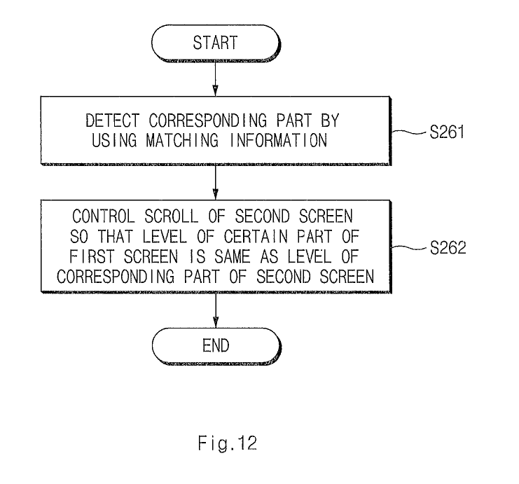

FIG. 11 is a flow chart of a method of controlling the display of a terminal device according to another embodiment of the present disclosure. FIG. 12 is a detailed flow chart of step S260 in FIG. 11. Although FIGS. 11 and 12 show when a certain part of a first string is selected by a user, the present disclosure is not limited thereto and it will be understood that a case where a certain part of a second string is selected by the user can also be applied equally to the technical spirit to be described below.

Firstly, referring to FIG. 11, the method of controlling the display of a terminal device according to another embodiment of the present disclosure can include displaying the first string on a first screen in step S210, generating the second string relevant to the first string in step S220, generating matching information between the first string and the second string in step S230, displaying the second string on the second screen in step S240, determining whether a synchronization mode is selected in step S250, controlling the scroll of the second screen so that a corresponding part of the second string is displayed on the second screen based on the matching information when a certain part of the first string is selected in step S260, highlighting a corresponding part of the second string in step S270, and controlling the scrolls of the first screen and the second screen independently in step S280.

Step S260 can include detecting the corresponding part of the second string by using the matching information in step S261, and controlling the scroll of the second screen so that a level of the certain part of the first screen is the same as a level of the corresponding part of the second screen, in step S262.

Steps S260 and S270 can be performed when the synchronization mode is selected as the determination result of step S250, and step S280 can be performed when the synchronization mode is not selected as the determination result of step S250. In the following, each of steps S210 to S280 will be described in detail.

Since steps S210 to S250 are the same as steps S110 to S150 described with reference to FIG. 10, their descriptions are not provided.

In step S260, when the certain part of the first string S1 is selected by a user, the controller 120 can control the scroll of the second screen 132 so that the corresponding part of the second string S2 is displayed on the second screen 132 by using the matching information.

In step S261, the controller 120 can detect the corresponding part of the second string S2 by using the matching information. That is, the controller 120 can detect location information on the corresponding part of the second string S2 corresponding to location information on the certain part of the first string S1 by using the matching information stored in the storage medium 140.

In step S262, the controller 120 can control the scroll of the second screen 132 so that a level of the certain part of the first string S1 on the first screen 131 is the same as a level of the corresponding part of the second string S2 of the second screen 132.

In step S270, the controller 120 can highlight H2 the corresponding part of the second string S2.

On the other hand, step S280 can be the same as step S170 described with reference to FIG. 10.

FIG. 13 shows a communication system according to an embodiment of the present disclosure.

Referring to FIG. 13, a communication system 1000 according to an embodiment of the present disclosure can include a terminal device 1100 and a server 1200. The terminal device 1100 and the server 1200 can be connected to each other over a communication network 1300.

The terminal device 1100 can store a first string. For example, the terminal device 100 can obtain the first string from a user and store the obtained first string. Unlike the terminal device 100 described in FIG. 1, the terminal device 1100 may not autonomously generate a second string relevant to the first string but deliver the first string to the server 1200.

The server 1200 can process (for example, translate) the first string delivered from the terminal device 1100 and generate the second string. Also, the server 1200 can generate matching information between the first string and the second string and deliver the generated matching information to the terminal device 1100. That is, according to the communication system 1000, the server 1200 generates the second string and the matching information between the first string and the second string, so it is possible to decrease a load of the terminal device 1100 and enhance performance.

The terminal device 1100 can receive the second string and the matching information delivered from the server 1200. When a certain part of the first string or the second string is selected by using the matching information or a scroll control command for the first screen or the second screen is input, the terminal device 1100 can control the scrolls of the first screen and the second screen based on the matching information delivered from the server 1200.

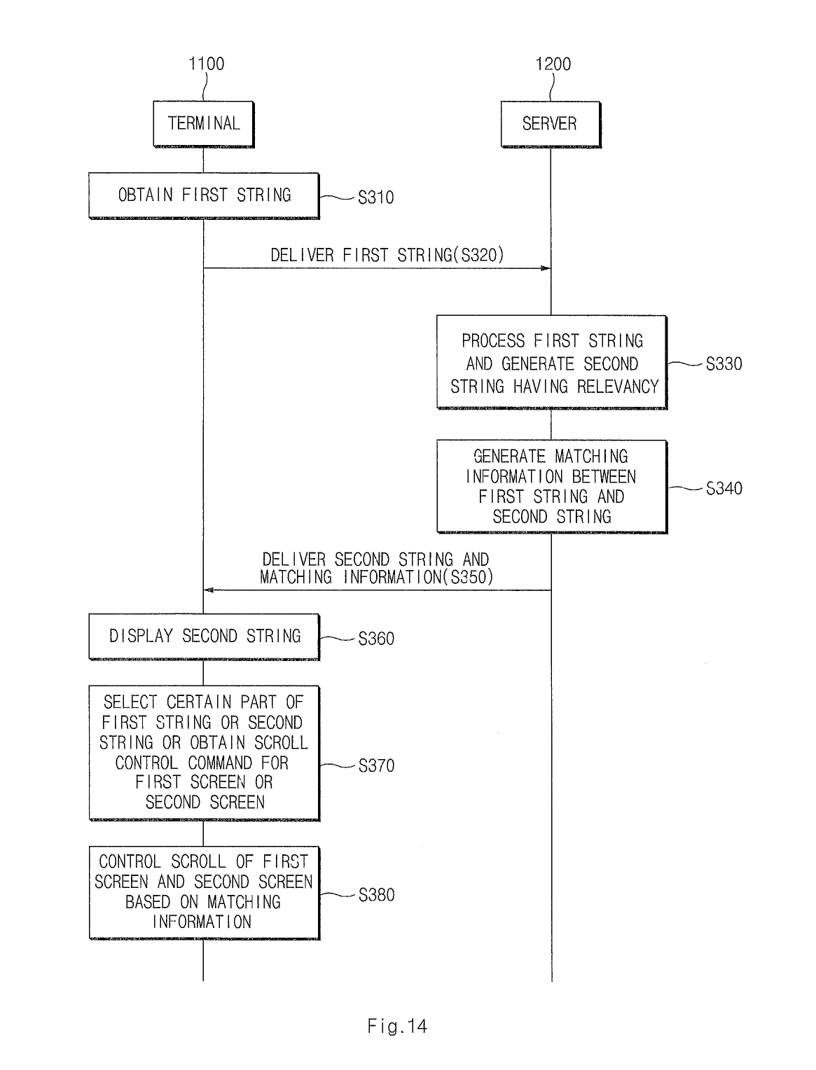

FIG. 14 is a flow chart of the operation of the communication system of FIG. 13.

Referring to FIG. 14, the terminal device 1100 can obtain a first string from a user in step S310. On the other hand, although not shown in FIG. 14, the terminal device 1100 can display the obtained first string on a first screen. However, the present disclosure is not limited thereto and the terminal device 1100 can also display a pre-stored first string on the first screen.

Next, the terminal device 1100 can deliver the first string to the server 1200 in step S320. The server 1200 can process (for example, translate) the first string and generate a second string relevant to the first string in step S330. The server 1200 can generate matching information between the first string and the second string. In addition, the server 1200 will deliver the second string and the generated matching information to the terminal device 1100.

The terminal device 1100 receiving the second string and the matching information from the server 1200 can display the second string on the second screen in step S360.

Next, the first string or a certain part of the first string can be selected or a scroll control command for the first screen or the second screen can be input to the terminal device 1100 in step S370. In this case, the terminal device 1100 will use the matching information delivered from the server 1200 to control the scroll of the first screen and the second screen in step S380.

On the other hand, various embodiments described in the present disclosure can be implemented in a recording medium that can be read with a computer or a similar device by using software, hardware or a combination thereof. According to a hardware implementation, the embodiments described in the present disclosure can be implemented by using at least one of application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electrical units for performing functions.

A terminal device, a method of controlling the display of the terminal device, and a communication system including the terminal device according to an embodiment of the disclosure can efficiently control a plurality of displayed screens.

Also, a terminal device, a method of controlling the display of the terminal device, and a communication system including the terminal device according to an embodiment of the disclosure can enhance user convenience when using the terminal device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A terminal device comprising:
a storage medium configured to store a first string and a second string relevant to the first string;
a display configured to display the first string on a first screen and the second string on a second screen; and
a controller configured to generate sentence-by-sentence matching information between the first string and the second string, and control scrolls of the first screen and the second screen based on the sentence-by-sentence matching information when a certain part of the first string or the second string is selected or a scroll control command for the first screen or the second screen is input.

2. The terminal device according to claim 1, wherein the controller is configured to use a line feed character or period information included in the first string to generate the sentence-by-sentence matching information.

3. The terminal device according to claim 1, wherein when the certain part of the first string is selected, the controller is configured to use the sentence-by-sentence matching information to detect a corresponding part of the second string matching with the certain part and controls the scroll of the second screen to allow the corresponding part to be displayed on the second screen.

4. The terminal device according to claim 3, wherein the controller is configured to control the scroll of the second screen to allow a level of the certain part of the first screen to be the same as a level of the corresponding part of the second screen.

5. The terminal device according to claim 3, wherein the display is configured to highlights the corresponding part.

6. The terminal device according to claim 3, wherein the certain part and the corresponding part are a word, a sentence or a paragraph.

7. The terminal device according to claim 1, wherein when a scroll-up command for the first screen or the second screen is input, the controller is configured to scroll up the first screen and the second screen.

8. The terminal device according to claim 1, wherein when a scroll-down command for the first screen or the second screen is input, the controller is configured to scroll down the first screen and the second screen.

9. The terminal device according to claim 1, wherein the certain part is selected by a touch or a contactless proximity touch.

10. The terminal device according to claim 1, wherein the display is configured to display the first screen and the second screen without overlap.

11. The terminal device according to claim 1, wherein the controller is configured to translate the first string and generates the second string.

12. The terminal device according to claim 1, wherein the second string is generated from an external server and delivered to the storage medium.

13. The terminal device according to claim 1, wherein the storage medium is configured to store the sentence-by-sentence matching information.

14. A method of controlling a display of a terminal device, the method comprising:
displaying a first string on a first screen;
generating a second string relevant to the first string;
generating sentence-by-sentence matching information between the first string and the second string;
displaying the second string on a second screen;
controlling a scroll of the second screen to allow a corresponding part of the second string matching with a certain part of the first string to be displayed on the second screen based on the sentence-by-sentence matching information when the certain part is selected.

15. The method according to claim 14, wherein the controlling of the scroll of the second-screen includes:
using the sentence-by-sentence matching information to detect the corresponding part; and
controlling the scroll of the second screen to allow a level of the certain part of the first screen to be the same as a level of the corresponding part of the second screen.

16. The method according to claim 14, further comprising highlighting the corresponding part.

17. The method according to claim 14, further comprising controlling scrolls of the first screen and the second screen based on the sentence-by-sentence matching information when a scroll control command for the first screen or the second screen is input.

18. A communication system comprising:
a terminal configured to store a first string; and
a server configured to process the first string delivered from the terminal, generate a second string relevant to the first string, and generate sentence-by-sentence matching information between the first string and the second string,
wherein the server is configured to deliver the second string and the sentence-by-sentence matching information to the terminal,
the terminal is configured to display the first string on a first screen and the second string on a second screen, and
the terminal is configured to control scrolls of the first screen and the second screen based on the sentence-by-sentence matching information delivered from the server when a certain part of the first string or the second string is selected or a scroll control command for the first screen or the second screen is input.

19. The communication system according to claim 18, wherein the terminal includes:
a storage medium configured to store the first string and the second string;
a display configured to display the first string on the first screen and the second string on the second screen; and
a controller configured to control the scrolls of the first screen and the second screen based on the sentence-by-sentence matching information when a certain part of the first string or the second string is selected or a scroll control command for the first screen or the second screen is input.

20. The communication system according to claim 19, wherein when the certain part of the first string is selected, the controller is configured to use the sentence-by-sentence matching information to detect a corresponding part of the second string matching with the certain part and controls the scroll of the second screen to allow the corresponding part to be displayed on the second screen.
